(19) United States
(12) Patent Application Publication
(10) Pub. No.: US 2024/0058925 A1
(43) Pub. Date: Feb. 22, 2024

(54) DRIVERS, REVERSIBLE SOCKETS, AND METHODS OF USE AND MANUFACTURE THEREOF

(71) Applicant: DiversiTech Corporation, Duluth, GA (US)

(72) Inventor: Jonathan Mark Sada, Lawrenceville, GA (US)

(21) Appl. No.: 18/271,218

(22) PCT Filed: Jan. 11, 2022
(86) PCT No.: PCT/US2022/011895

§ 371 Date: Jul. 6, 2023

Related U.S. Application Data
(60) Provisional application No. 63/135,942, filed on Jan. 11, 2021.

(51) Int. Cl. B25B 13/06; B25B 13/56; B25B 23/12; B25B 23/00

(52) U.S. Cl. CPC B25B 13/06; B25B 13/56; B25B 23/12; B25B 23/0035

(57) ABSTRACT

Generally, this disclosure enables various drivers, reversible sockets, and methods of use and manufacture thereof. For example, some of these drivers can avoid laterally rolling off an inclined surface (e.g., between about 15 degrees and about 25 degrees). For example, some of these drivers can avoid using excessive material. For example, some of these drivers can allow for stacking of drivers and thereby be efficient to package for shipping. For example, some of these sockets can provide a tactile feedback for a user to know which ends of those sockets are currently being handled.

### CROSS REFERENCE

This patent application claims the benefit of U.S. Patent Application 63/135,942 filed 11 Jan. 2021; which is incorporated herein by reference for all purposes.

### BACKGROUND

Each of U.S. Pat. Nos. 9,981,366 and 10,328,554 describes a socket and a driver having an annular collar, where the socket has a pair of opposing and differently-sized ends, each mountable onto the driver up to the annular collar. Although this technology may sometimes be useful, this technology still suffers from various drawbacks. First, when the driver is placed onto an inclined surface (e.g., between about 15 degrees and about 25 degrees), the annular collar may cause the driver to laterally roll off the inclined surface, which is not desired at a job site. Second, when the driver is manufactured, there is excessive material used, which is not desired in terms of manufacturing complexity and financial costs. Third, when the driver is packaged for shipping, then the annular collar does not allow for stacking of drivers and therefore consumes more space than necessary, which is not desired during shipping. Fourth, the socket does not provide a tactile feedback for a user to know which of the differently-sized ends of the socket is currently being handled.

### SUMMARY

Generally, this disclosure enables various drivers, reversible sockets, and methods of use and manufacture thereof. For example, some of these drivers can avoid laterally rolling off an inclined surface (e.g., between about 15 degrees and about 25 degrees). For example, some of these drivers can avoid using excessive material. For example, some of these drivers can allow for stacking of drivers and thereby be efficient to package for shipping. For example, some of these sockets can provide a tactile feedback for a user to know which ends of those sockets are currently being handled.

In an embodiment, a device comprises: a driver including a shaft, a first projection, and a second projection, wherein the shaft includes a first end portion and a second end portion, wherein each of the first projection and the second projection extends from the shaft between the first end portion and the second end portion; and a socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against each of the first projection and the second projection.

In an embodiment, a device comprising: a driver including a shaft and a non-annular collar, wherein the shaft includes a first end portion and a second end portion, wherein the non-annular collar extends from the shaft between the first end portion and the second end portion; and a socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against the non-annular collar.

In an embodiment, a device comprising: a driver including a shaft including at least one of (a) a non-annular collar or (b) a first projection and a second projection, wherein the shaft includes a first end portion and a second end portion, wherein at least one of (a) the non-annular collar or (b) each of the first projection and the second projection extends from the shaft between the first end portion and the second end portion; and a socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against at least one of (a) the non-annular collar or (b) each of the first projection and the second projection.

In an embodiment, a kit comprising: a package; a driver including a shaft including at least one of (a) a non-annular collar or (b) a first projection and a second projection, wherein the shaft includes a first end portion and a second end portion, wherein at least one of (a) the non-annular collar or (b) each of the first projection and the second projection extends from the shaft between the first end portion and the second end portion, wherein the package contains the driver; and a socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against at least one of (a) the non-annular collar or (b) each of the first projection and the second projection, wherein the package contains the socket.

In an embodiment, a method comprising: manufacturing a driver including a shaft including at least one of (a) a non-annular collar or (b) a first projection and a second projection, wherein the shaft includes a first end portion and a second end portion, wherein at least one of (a) the non-annular collar or (b) each of the first projection and the second projection extends from the shaft between the first end portion and the second end portion; and manufacturing a socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against at least one of (a) the non-annular collar or (b) each of the first projection and the second projection.

In an embodiment, a method comprising: providing a driver and a socket to a user, wherein the driver including a shaft including at least one of (a) a non-annular collar or (b) a first projection and a second projection, wherein the shaft includes a first end portion and a second end portion, wherein at least one of (a) the non-annular collar or (b) each of the first projection and the second projection extends from the shaft between the first end portion and the second end portion, wherein the socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against at least one of (a) the non-annular collar or (b) each of the first projection and the second projection; and instructing the user to respectfully have the third end portion or the fourth end portion engage a fastener while the fourth end portion or the third end portion is respectfully mounted onto the first end portion up to or against at least one of (a) the non-annular collar or (b) each of the first projection and the second projection.

In an embodiment, a method comprising: providing a driver and a socket to a user, wherein the driver including a shaft including at least one of (a) a non-annular collar or (b) a first projection and a second projection, wherein the shaft includes a first end portion and a second end portion, wherein at least one of (a) the non-annular collar or (b) each of the first projection and the second projection extends from the shaft between the first end portion and the second end portion, wherein the socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against at least one of (a) the non-annular collar or (b) each of the first projection and the second projection; and instructing the user to respectfully have the third end portion or the fourth end portion disengage a fastener while the fourth end portion or the third end portion is respectfully mounted onto the first end portion up to or against at least one of (a) the non-annular collar or (b) each of the first projection and the second projection.

In an embodiment, a method comprising: accessing a driver and a socket, wherein the driver including a shaft including at least one of (a) a non-annular collar or (b) a first projection and a second projection, wherein the shaft includes a first end portion and a second end portion, wherein at least one of (a) the non-annular collar or (b) each of the first projection and the second projection extends from the shaft between the first end portion and the second end portion, wherein the socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against at least one of (a) the non-annular collar or (b) each of the first projection and the second projection; inserting a fastener into the third end portion or the fourth end portion while the fourth end portion or the third end portion is respectfully mounted onto the first end portion up to or against at least one of (a) the non-annular collar or (b) each of the first projection and the second projection.

In an embodiment, a method comprising: accessing a driver and a socket, wherein the driver including a shaft including at least one of (a) a non-annular collar or (b) a first projection and a second projection, wherein the shaft includes a first end portion and a second end portion, wherein at least one of (a) the non-annular collar or (b) each of the first projection and the second projection extends from the shaft between the first end portion and the second end portion, wherein the socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against at least one of (a) the non-annular collar or (b) each of the first projection and the second projection; removing a fastener from the third end portion or the fourth end portion while the fourth end portion or the third end portion is respectfully mounted onto the first end portion up to or against at least one of (a) the non-annular collar or (b) each of the first projection and the second projection.

### DESCRIPTION OF DRAWINGS

FIG. 1 shows an embodiment of a reversible socket according to this disclosure.

FIG. 2 shows an embodiment of an open end portion of a reversible socket according to this disclosure.

FIG. 3 shows an embodiment of an open end portion of a reversible socket according to this disclosure.

FIG. 4 shows an embodiment of a reversible socket according to this disclosure.

FIG. 5 shows an embodiment of a reversible socket according to this disclosure.

FIG. 6 shows an embodiment of a reversible socket according to this disclosure.

FIG. 7 shows an embodiment of a reversible socket according to this disclosure.

FIG. 8 shows an embodiment of a driver according to this disclosure.

FIG. 9 shows an embodiment of an end portion of a driver according to this disclosure.

FIG. 10 shows an embodiment of an end portion of a driver according to this disclosure.

FIG. 11 shows an embodiment of a driver according to this disclosure.

FIG. 12 shows an embodiment of a driver according to this disclosure.

FIG. 13 shows an embodiment of a driver according to this disclosure.

FIG. 14 shows an embodiment of a driver according to this disclosure.

FIG. 15 shows an embodiment of a driver before insertion into a chuck of a drill according to this disclosure.

FIG. 16 shows an embodiment of a driver after insertion into a chuck of a drill according to this disclosure.

FIG. 17 shows an embodiment of a driver resting on a flat surface without laterally rolling according to this disclosure.

FIG. 18 shows a cross-section of an embodiment of a driver according to this disclosure.

FIG. 19 shows an embodiment of a reversible socket before mounting onto a driver according to this disclosure.

FIG. 20 shows a cross-section of an embodiment of a reversible socket after mounting onto a driver according to this disclosure.

FIG. 21 shows an embodiment of a reversible socket before mounting onto a driver according to this disclosure.

FIG. 22 shows a cross-section of an embodiment of a reversible socket after mounting onto a driver according to this disclosure.

FIG. 23 shows a cross-section of a reversible socket mounted onto a driver having a magnet attracting a shaving according to this disclosure.

### DETAILED DESCRIPTION

Generally, this disclosure enables various drivers, reversible sockets, and methods of use and manufacture thereof. For example, some of these drivers can avoid laterally rolling off an inclined surface (e.g., between about 15 degrees and about 25 degrees). For example, some of these drivers can avoid using excessive material. For example, some of these drivers can allow for stacking of drivers and thereby be efficient to package for shipping. For example, some of these sockets can provide a tactile feedback for a user to know which ends of those sockets are currently being handled. However, note that this disclosure may be embodied in many different forms and should not be construed as necessarily being limited to various embodiments disclosed herein. Rather, these embodiments are provided so that this disclosure is thorough and complete, and fully conveys various concepts of this disclosure to skilled artisans.

Note that various terminology used herein can imply direct or indirect, full or partial, temporary or permanent, action or inaction. For example, when an element is referred to as being “on,” “connected,” or “coupled” to another element, then the element can be directly on, connected, or coupled to another element or intervening elements can be present, including indirect or direct variants. In contrast, when an element is referred to as being “directly connected” or “directly coupled” to another element, then there are no intervening elements present.

As used herein, various singular forms “a,” “an” and “the” are intended to include various plural forms (e.g., two, three, four, five, six, seven, eight, nine, ten, tens, hundreds, thousands) as well, unless specific context clearly indicates otherwise.

As used herein, various presence verbs “comprises,” “includes” or “comprising,” “including” when used in this specification, specify a presence of stated features, integers, steps, operations, elements, or components, but do not preclude the presence or addition of one or more other features, integers, steps, operations, elements, components, or groups thereof.

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

As used herein, a term “or others,” “combination”, “combinatory,” or “combinations thereof” refers to all permutations and combinations of listed items preceding that term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. Skilled artisans understand that typically there is no limit on number of items or terms in any combination, unless otherwise apparent from the context.

As used herein, unless otherwise defined, all terms (including technical and scientific terms) used herein have the same meaning as commonly understood by one of ordinary skill in an art to which this disclosure belongs. Various terms, such as those defined in commonly used dictionaries, should be interpreted as having a meaning that is consistent with a meaning in a context of a relevant art and should not be interpreted in an idealized or overly formal sense, unless expressly so defined herein.

As used herein, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

As used herein, a term “about” or “substantially” refers to a +/−10% variation from a nominal value/term. Such variation is always included in any given value/term provided herein, whether or not such variation is specifically referred thereto.

Features described with respect to certain embodiments may be combined in or with various some embodiments in any permutational or combinatory manner. Different aspects or elements of example embodiments, as disclosed herein, may be combined in a similar manner.

Although the terms first, second, can be used herein to describe various elements, components, regions, layers, or sections, these elements, components, regions, layers, or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from various teachings of this disclosure.

Features described with respect to certain example embodiments can be combined and sub-combined in or with various other example embodiments. Also, different aspects or elements of example embodiments, as disclosed herein, can be combined and sub-combined in a similar manner as well. Further, some example embodiments, whether individually or collectively, can be components of a larger system, wherein other procedures can take precedence over or otherwise modify their application. Additionally, a number of steps can be required before, after, or concurrently with example embodiments, as disclosed herein. Note that any or all methods or processes, at least as disclosed herein, can be at least partially performed via at least one entity in any manner.

Example embodiments of this disclosure are described herein with reference to illustrations of idealized embodiments (and intermediate structures) of this disclosure. As such, variations from various illustrated shapes as a result, for example, of manufacturing techniques or tolerances, are to be expected. Thus, various example embodiments of this disclosure should not be construed as necessarily limited to various particular shapes of regions illustrated herein, but are to include deviations in shapes that result, for example, from manufacturing.

Any or all elements, as disclosed herein, can be formed from a same, structurally continuous piece, such as being unitary, or be separately manufactured or connected, such as being an assembly or modules. Any or all elements, as disclosed herein, can be manufactured via any manufacturing processes, whether additive manufacturing, subtractive manufacturing, or other any other types of manufacturing. For example, some manufacturing processes include three dimensional (3D) printing, laser cutting, computer numerical control routing, milling, pressing, stamping, vacuum forming, hydroforming, injection molding, lithography, chiseling, and so forth.

Hereby, all issued patents, published patent applications, and non-patent publications that are mentioned or referred to in this specification are herein incorporated by reference in their entirety for all purposes, to a same extent as if each individual issued patent, published patent application, or non-patent publication were specifically and individually indicated to be incorporated by reference. To be even more clear, all incorporations by reference specifically include those incorporated publications as if those specific publications are copied and pasted herein, as if originally included in this disclosure for all purposes of this disclosure. Therefore, any reference to something being disclosed herein includes all subject matter incorporated by reference, as explained above. However, if any disclosures are incorporated herein by reference and such disclosures conflict in part or in whole with this disclosure, then to an extent of the conflict or broader disclosure or broader definition of terms, this disclosure controls. If such disclosures conflict in part or in whole with one another, then to an extent of conflict, the later-dated disclosure controls.

Each of U.S. Pat. Nos. 9,981,366 and 10,328,554 is incorporated by reference herein for all purposes. For example, some of such purposes can include a material, a property, a structure, a shape, a size, a scale, a proportion, or a function of a socket or a component thereof, a driver or a component thereof, a device including the socket and the driver or a component thereof, or a method of manufacture or use of the socket, the driver, or the device including the socket and the driver, as disclosed herein.

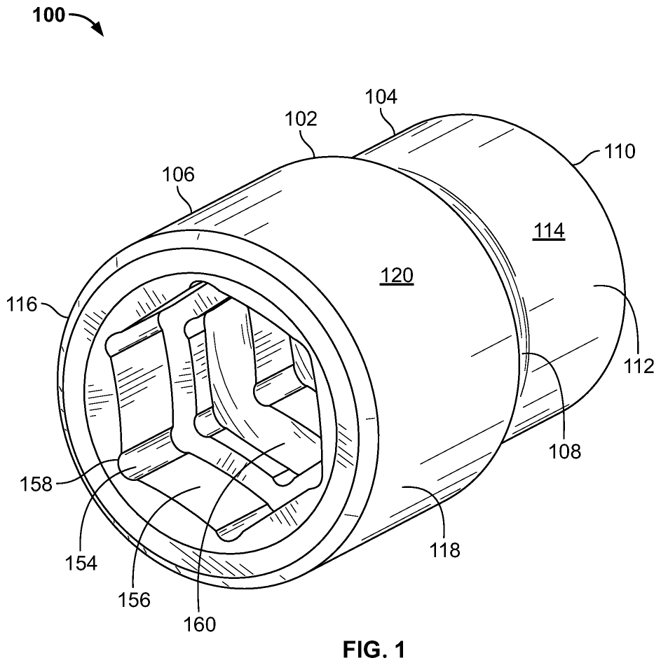

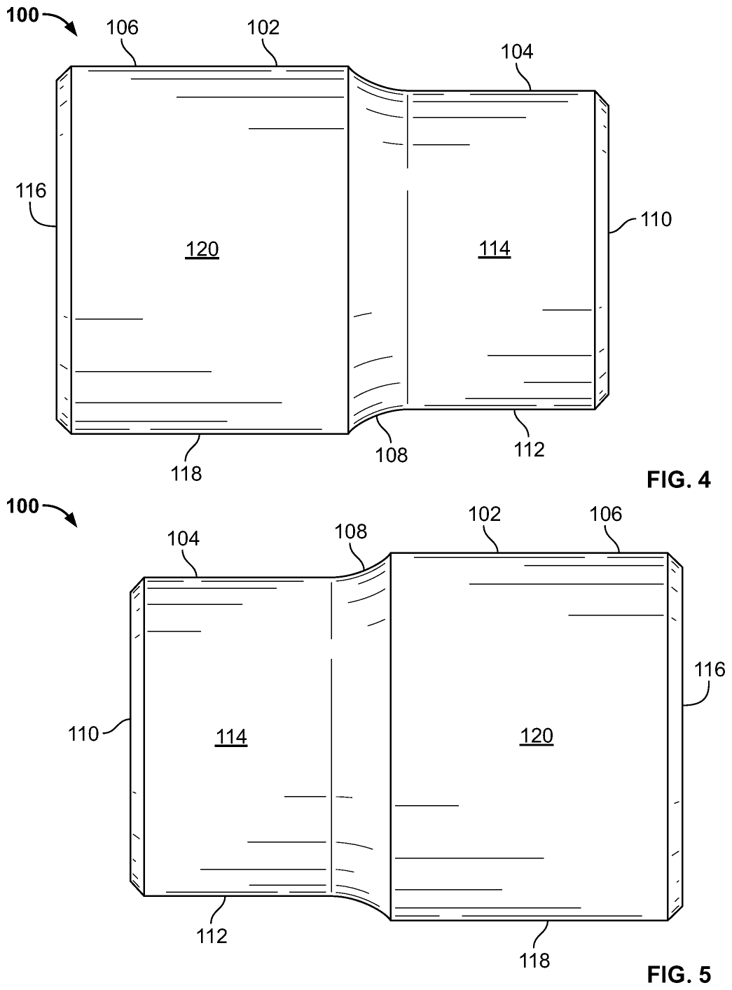

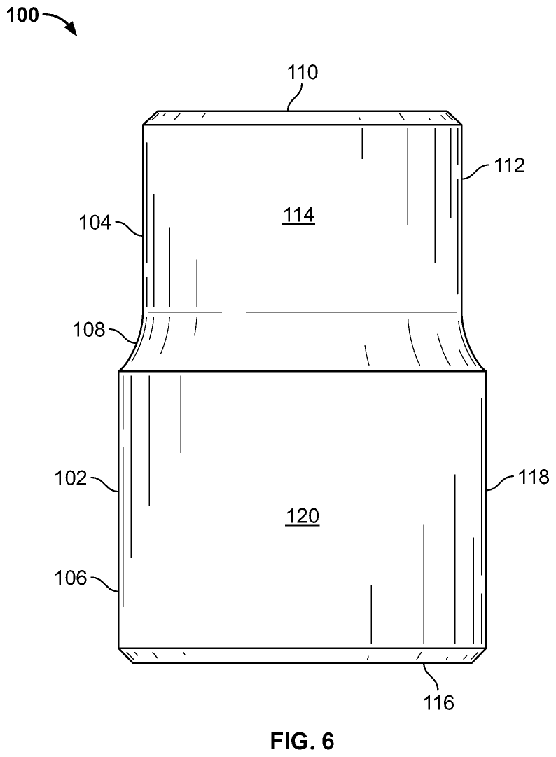

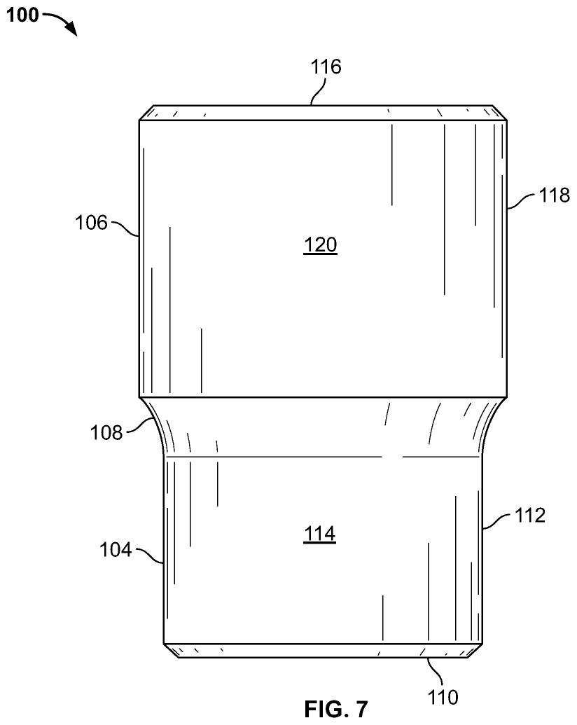

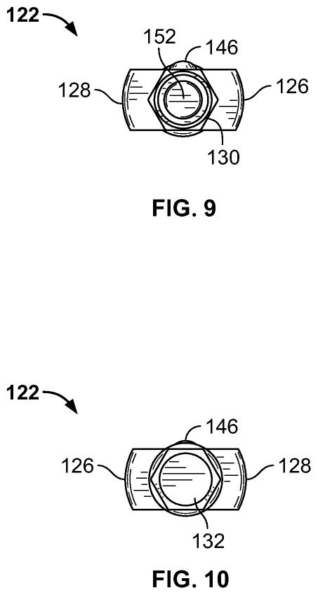

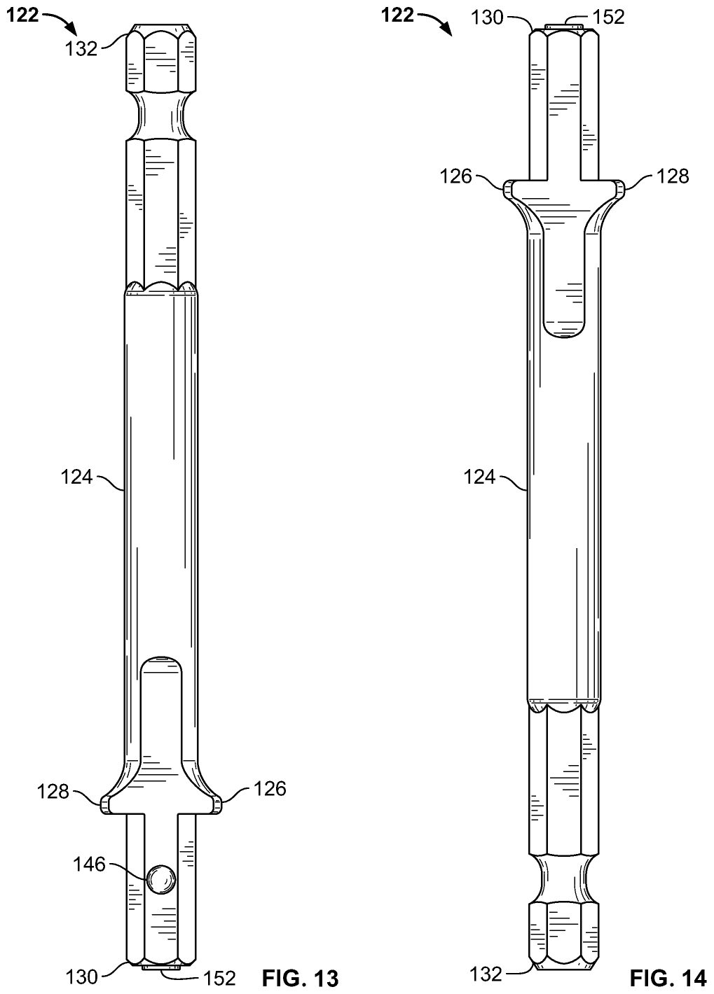

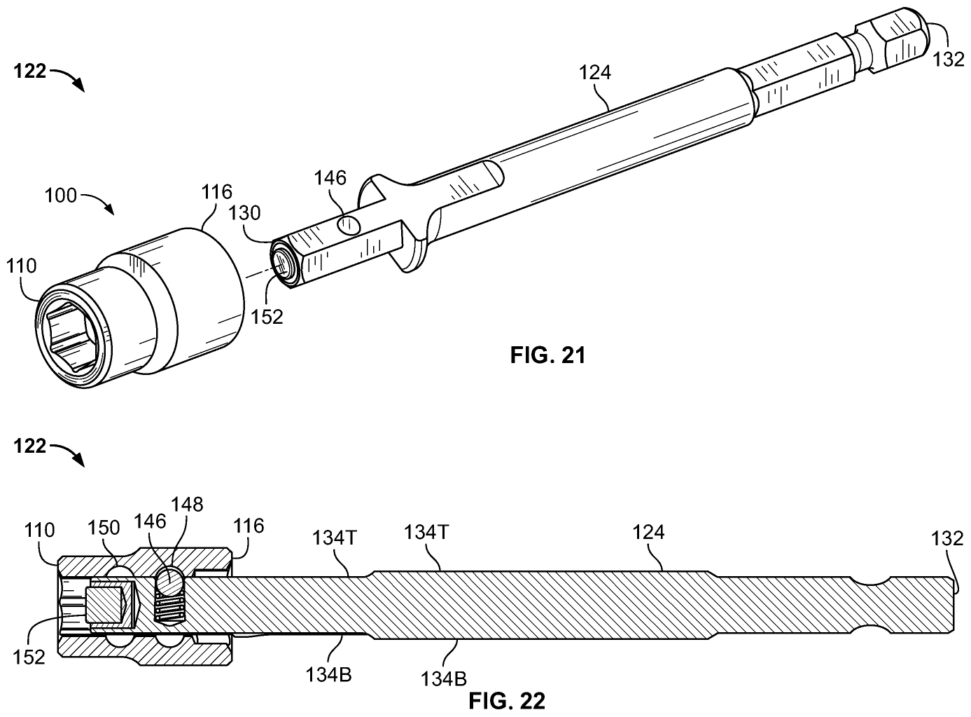

As shown in FIGS. 1-23, various drivers and various reversible sockets can be used in various applications, including tightening and loosening of various fasteners (e.g., bolts, nuts, screws). These drivers and reversible sockets are technologically advantageous for various reasons.

For example, with respect to these drivers, some of these drivers can include a shaft, which does not have an annular collar that extends from the shaft. Instead, the shaft can include a non-annular collar, a projection, or a set of projections extending from the shaft. For example, the non-annular collar can be shaped as a square, rectangle, triangle, a pentagon, a hexagon, or others. As such, the non-annular collar, the projection, or the set of projections can enable a technological benefit of preventing or minimizing the driver from laterally rolling off an inclined surface (e.g., between about 15 degrees and about 25 degrees) when the driver is placed on the inclined surface, thereby making the driver easier to place onto the inclined surface, locate on the inclined surface, and lift of the inclined surface, especially at a job site. Further, the non-annular collar, the projection, or the set of projections can be externally coated with a friction-enhancing material (e.g., a rubber) to reduce sliding on a surface, whether inclined or level, or to further prevent or minimize the driver from laterally rolling off an inclined surface (e.g., between about 15 degrees and about 25 degrees) when the driver is placed on the inclined surface, thereby making the driver easier to place onto the inclined surface, locate on the inclined surface, and lift of the inclined surface, especially at a job site. Additionally, the non-annular collar, the projection, or the set of projections can effectively minimize or reduce usage of excess material in manufacture, thereby decreasing manufacturing complexity and financial costs. Moreover, the shaft can have a flat side (e.g., a top side, a bottom side, a lateral side), which provides a technological benefit of having the driver being able to be easily stacked on top of another driver. This stacking ability enables packing of the driver more tightly with other drivers, while in transit or storage. For example, having the flat side can enable the driver to be efficiently packaged with other drivers in a shipping package. This form of packaging can also enable the shipping package to be made smaller and therefore more economical and simple to use and store.

For example, with respect to these reversible sockets, some of these reversible sockets can have two different open end portions, i.e., each end portion having an opening with a different size with respect to its opposing opening in order to fit or receive different sizes of various fasteners (e.g., bolts, nuts, screws), yet still be removably and securely mountable onto a respective driver. Also, some of these reversible sockets can have two different external surface areas corresponding to a respective size of a respective opening of the reversible socket. As such, due to such size differences, a user can easily and quickly determine, simply by a tactile feeling of the external surface areas of the reversible socket, without looking, which opening size belongs to which open end portion of the reversible socket. Further, some of these different external surface areas can have different tactile content disposed thereon (e.g., projected, embossed, Braille-like). The tactile content differs between the different external surface areas in order to help a user to distinguish by touch, without looking, which of the different surface areas of the reversible socket is currently being handled.

Referring to FIGS. 1-7, a reversible socket 100 includes a tube 102 having a first tubular portion 104, a second tubular portion 106, and a third tubular portion 108. The third tubular portion 108 is interposed between the first tubular portion 104 and the second tubular portion 106. However, note that the third tubular portion 108 can be omitted such that the first tubular portion 104 extends from the second tubular portion 106 and vice versa.

The first tubular portion 104 and the second tubular portion 106 are identical in length. However, this configuration may vary and the first tubular portion 104 and the second tubular portion 106 are not identical in length. This can enable a technological benefit of enabling a user to determine in a tactile manner which tubular portion is being currently handled.

The first tubular portion 104 has a first open end portion 110 (e.g., flat, beveled, chamfered) and a first outer side 112 with a first surface area 114. The second tubular portion 106 has a second open end portion 116 (e.g., flat, beveled, chamfered) and a second outer side 118 with a second surface area 120. Although each of the first open end portion 110 and the second open end portion 116 is beveled, this configuration can differ. For example, the first open end portion 110 can be beveled and the second open end portion 116 can be chamfered or flat.

The socket 100 has an inner surface 156 defining an inner cavity 160 spanning between the first open end portion 110 and the second open end portion 116 such that the first open end portion 110 and the second open end portion 116 are in fluid communication with each other through the cavity 160. However, note that the socket 100 may host a partition (e.g., a wall, a projection) therein to partition (e.g., perpendicularly, bevel, chamfer) the cavity 160 into a first cavity spanning between the first open end portion 110 and the partition and a second cavity spanning between the second open end portion 116 and the partition. The partition can be interposed between the first cavity and the second cavity, whether the first cavity and the second cavity are or are not in fluid communication with each other, whether the first cavity and the second cavity are or are not equal to each other in volume or shape. The partition may be solid (e.g., to prevent spread of shavings) or perforated (e.g., to provide a cooling effect). The partition may extend within the first tubular portion 104, the second tubular portion 106, or the third tubular portion 108.

Each of the first tubular portion 104 and the second tubular portion 106 has a circular cross-section, but this shaping can vary (e.g., polygonal, triangular, square, rectangle, pentagonal, hexagonal, teardrop, crescent), whether the first tubular portion 104 and the second tubular portion 106 are identical or not identical to each other in cross-section. Likewise, each of the first tubular portion 104 and the second tubular portion 106 has a symmetrical shape, but this can vary (e.g., asymmetrical shape), whether the first tubular portion 104 and the second tubular portion 106 are identical or not identical to each other in symmetry.

The inner surface 156 is smooth, but can be rough, knurled, or textured. Each of the first open end portion 110 and the second open end portion 116 has the inner surface 156 defining a polygonal shape (e.g., pentagon, hexagon, triangle, square, rectangle, teardrop, crescent) sized to fit or receive a correspondingly-shaped fastener (e.g., bolt, nut, screw). For example, the polygonal shape may be sized to fit or receive a correspondingly-shaped head of a bolt or a nut. The inner surface 156 forms a set of vertices 158 with a set of channels 154 therein, which provide a set of open spaces between the correspondingly-shaped fastener and the set of the channels 154 when the correspondingly-shaped fastener is positioned within a respective open end portion of the socket 100. For example, the corresponding fastener may be a screw or a bolt, each having a head positioned within the first open end portion 110 or the second open end portion 116. The set of open spaces can enable at least some air movement into the reversible socket 100 in order to provide a cooling effect, which may be needed due to a heat formed from an application of pressure or resulting friction when driving the correspondingly-shaped fastener, as disclosed herein.

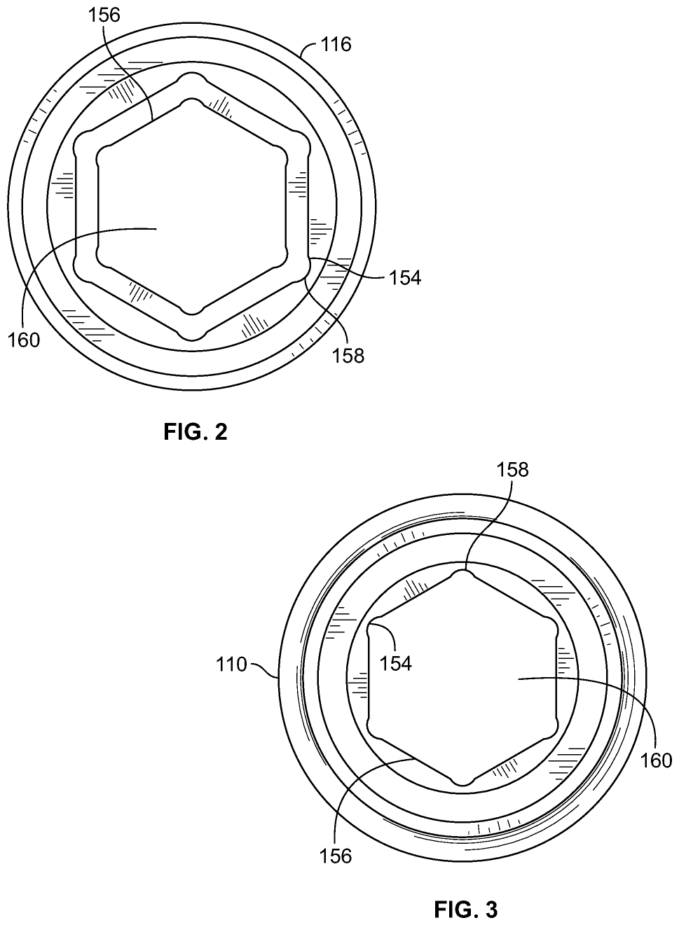

The first open end portion 110 and the second open end portion 112 have the inner surfaces 156 defining the polygonal shapes that are identical in shape, but different in scale, proportion, or size. However, note that this configuration may differ where the polygonal shapes are different in shape, whether identical or different in scale, proportion, or size. For example, as shown in FIGS. 2 and 3, each of the first open end portion 110 and the second open end portion 112 are hexagonal, but of different scales, proportions, or sizes. However, this configuration can differ where the first open end portion 110 has a first shape (e.g., a hexagon) and the second open end portion 112 has a second shape (e.g., square) different from the first shape, which can also differ or be same in size, proportion, or scale. For example, each of the first open end portion 110 and the second open end portion 116 includes an opening of a variety of shapes. These shapes can include polygonal shapes, including hexagonal, pentagonal, quadrilateral, triangular, heptagonal, octagonal, nonagonal, decagonal, square, rectangle, rhombus, teardrop, star, slot, slit, or others. The respective openings of the first open end portion 110 and the second open end portion 116 may be symmetrical or asymmetrical, and may shaped to accommodate a flat driver, a Phillips head-shaped driver, a star driver, a hex driver, a tri wing driver, or others. For example, the first open end portion 110 and the second open end portion 116 may have openings of different shapes from one another, may accommodate different shapes and types of drivers from one another, may be of different dimensions (e.g., inner or outer diameter, inner or outer radius, inner or outer lengths, inner or outer widths, inner or outer thicknesses) from one another.

Each of the first outer surface 114 and the second outer surface 120 are smooth, but can be rough, knurled, or textured (e.g., in order to provide more tactile or anti-rolling properties). Although each of the first outer surface 114 and the second outer surface 120 are smooth, this configuration can differ. For example, the first outer surface 114 can be smooth and the second outer surface 120 can be rough. For example, can be textured or knurled in a first pattern and the second outer surface 120 can be textured or knurled in a second pattern, where the first pattern differs from the second pattern in tactility.

Each of the first outer surface 114 and the second outer surface 120 are solid, but can be dimpled without entering the inner cavity 160 (e.g., to provide more tactility) or perforated by entering into the inner cavity 160 (e.g., to provide a cooling effect). Although each of the first outer surface 114 and the second outer surface 120 are solid, this configuration can differ. For example, the first outer surface 114 can be solid and the second outer surface 120 can be perforated.

As shown in FIGS. 1-7, the first surface area 114 is lesser in area than the second surface area 120. Correspondingly, the first open end portion 110 is lesser in area than the second open end portion 116. Therefore, this configuration can provide a technological benefit that enables a user to easily and quickly determine, simply by a tactile feeling of the first surface area 114 and the second surface area 120, without looking, whether the first outer side 112 or the second outer side 118 is being currently handled.

The third tubular portion 108 may be of various forms, including forms in which the third tubular portion 108 presents a gradual taper, abrupt step, indentation, or protrusion between the first tubular portion 104 and the second tubular portion 106. As shown in FIGS. 1-7, the third tubular portion is formed as the gradual taper and transitionally and gradually narrowing in outer diameter from the second tubular portion 106 to the first tubular portion 104. The third tubular portion 108 may also take forms in which the third tubular portion 108 can be of various cross-sections, whether identical or not identical to the first tubular portion 104 or the second tubular portion 106. As explained above, the third tubular portion 108 can be omitted.

The reversible socket 100 can host an opening size content on its outer side, i.e., on the first surface area 114 of the first outer side 112 or the second surface area 120 of the second outer side 118, whether on a same plane or different planes (e.g., both at 12 o'clock when resting on a flat surface, one at 12 o'clock and one at 6 o'clock when resting on a flat surface). For example, a first opening size content (e.g., a size of ¼ of an inch, ¼, 0.25) appears on the first surface area 114 of the first outer side 112 and a second opening size content appears on the second surface area 120 of the second outer side 118 (e.g., a size of 5/16 of an inch, 5/16, 0.31). This opening size content can be presented in various forms, including through etching, embedding, Braille, Braille-like, protrusion, depression, indentation, protrusion, applique, stickers, ink marking, laser marking, dot peen marking, scribe marking, stamping, branding, or others. For example, this opening size content can be tactile, in that the opening size content may be rougher than its surrounding material, smoother than its surrounding material, patterned in a different way than its surrounding material, of a different material than its surrounding material, elevated, depressed, embossed, outlined by an elevated or depressed ridge or edge, or otherwise be presented in such a way that a difference between the opening size content and other remaining area of a respective surface area of the reversible socket 100 can be felt in a tactile manner, without looking. For example, the first opening size content of the first tubular portion 104 and the second opening size content of the second tubular portion 106 may be co-planar with one another, or may be non-co-planar, including on opposite outer sides of the reversible socket 100, or at any of the various orientations between co-planar and opposite sides.

The reversible socket 100, including any of the tube 102, the first tubular portion 104, the second tubular portion 106, and the third tubular portion 108, includes a metal or an alloy (e.g., iron, steel, stainless steel, aluminum, nickel, copper, brass, gold, silver, rare earth, nitinol). However, this constituency may differ. For example, the reversible socket 100, including any of the tube 102, the first tubular portion 104, the second tubular portion 106, and the third tubular portion 108, can include a plastic, a rubber, a wood, shape memory, or others. Likewise, the reversible socket 100, including any of the tube 102, the first tubular portion 104, the second tubular portion 106, and the third tubular portion 108, is monolithic alone or with respect to the first tubular portion 104, the second tubular portion 106, and the third tubular portion 108. However, this configuration may differ. For example, the reversible socket 100, including any of the tube 102, the first tubular portion 104, the second tubular portion 106, and the third tubular portion 108, is an assembly (e.g., fastening, mating, interlocking) alone or with respect to the first tubular portion 104, the second tubular portion 106, and the third tubular portion 108.

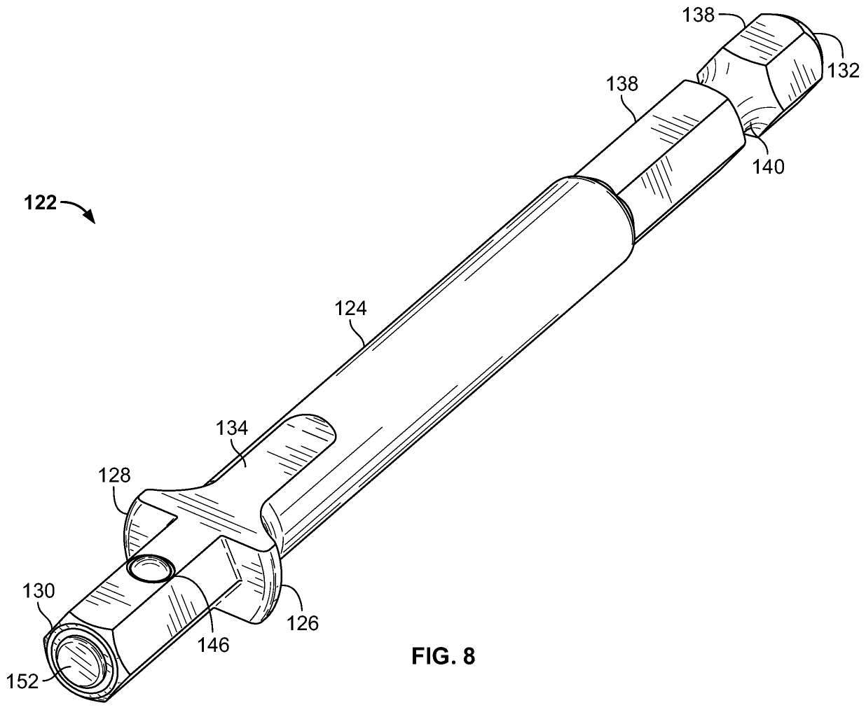

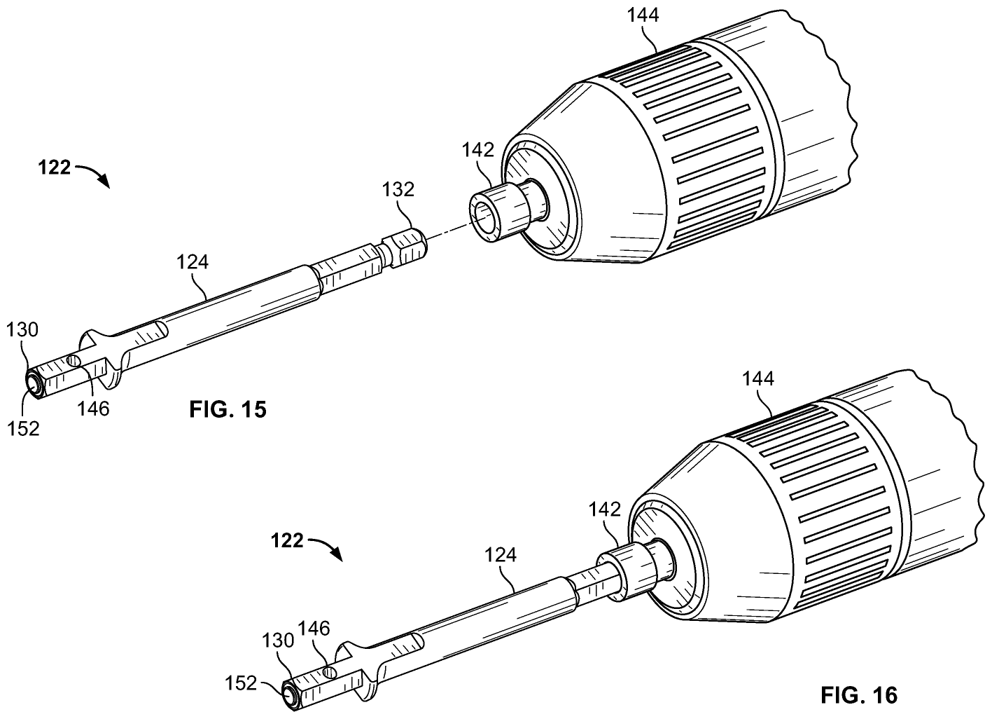

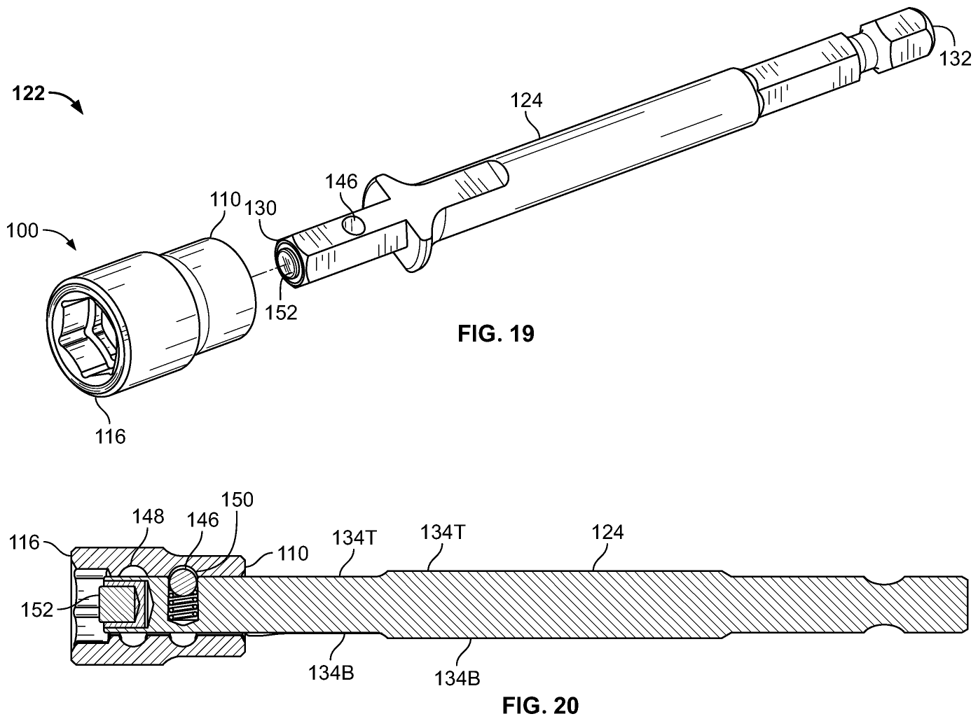

Referring to FIGS. 8-14, a driver 122 includes a shaft 124 having a first end portion 130 and a second end portion 132. The first open end portion 130 is configured for mating (e.g., insertion) with each of the first open end portion 110 and the second open end portion 116, as shown in FIGS. 19-23. The second end portion 132 is configured for mating (e.g., insertion) with a chuck of a drill (or another electrical, hydraulic, or pneumatic power tool), as shown in FIGS. 15-16. Although the shaft 124 is longitudinally symmetrical, this can vary and the shaft 124 can be longitudinally asymmetrical. The shaft 124 may be of various lengths, depending upon the particular use. For example, there may be a kit (e.g., a package, a box, a bag) that includes a set of shafts 124, where each member of the set of shafts 124 differs in longitudinal length between the first end portion 130 and the second end portion.

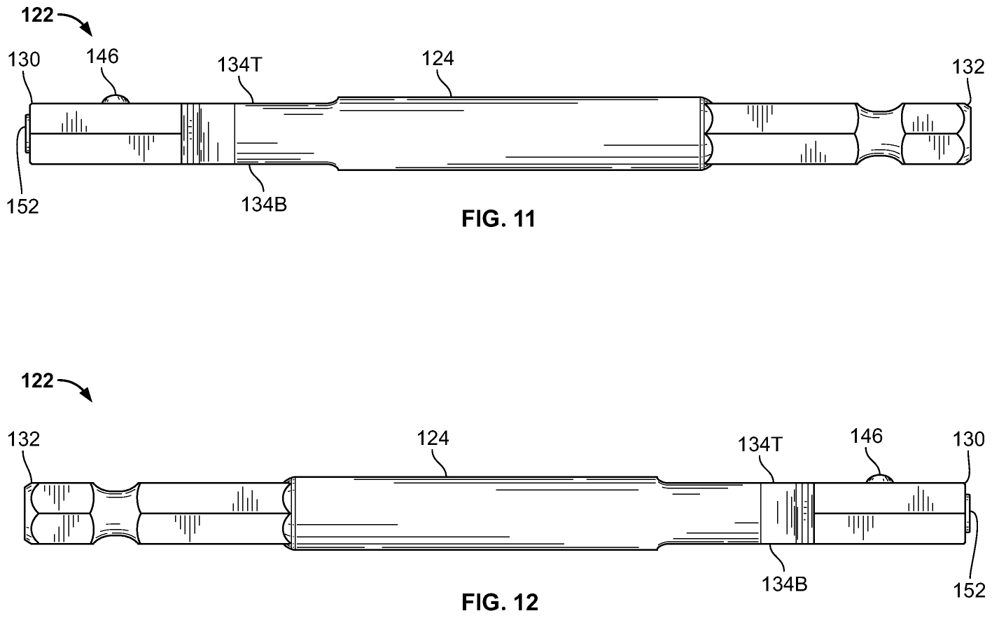

The shaft 124 has a set of flat portions 134, i.e., a top side 134A and a bottom side 134B, as shown in FIGS. 11-12 and 17-18. The set of flat portions 134 enables a technological benefit of stacking the driver 122 with other drivers 122 for more efficient storage or shipping. Note that the shaft 124 has at least one flat portion 134. Although the shaft 124 is partially flat via the set of flat portions 134, this configuration can vary where the shaft 124 is mostly flat via at least one of flat portions 13 on that respective side (e.g., at least about 51%, 66%, 75% longitudinally).

The shaft 124 has a first projection 126 and a second projection 128, any of which can be magnetized to attract to the reversible socket 100 or vice versa. The first projection 126 and the second projection 128 are spaced apart from each other and outwardly extend (e.g., radially) from the shaft 124 between the first end portion 130 and the second end portion 132. The first projection 126 and the second projection 128 extend from the shaft 124 in opposing directions (e.g., 3 o'clock and 9 o'clock respectfully when resting on a flat surface). For example, the first projection 126 and the second projection 128 can extend from the shaft 124 in diametrically opposing directions, although this is not required. This configuration provides a technological benefit of preventing the shaft 124 from laterally rolling off an inclined surface. However, note that this technological benefit can be obtained in other ways. For example, each of the first projection 126 and the second projection 128 can extend from the shaft 124 in non-opposing directions, whether additionally or alternatively (e.g., 12 o'clock when resting on a flat surface, 1 o'clock when resting on a flat surface, 6 o'clock when resting on a flat surface). For example, the shaft 124 may have a single projection, whether the first projection 126 or the second projection 128. For example, the shaft 124 can include more than two projections (more than the first projection 126 and the second projection 128), whether structurally identical or non-identical to either of the first projection 126 and the second projection 128. For example, these projections can be positioned at about 120 degrees from each other (3 projections), about 90 degrees from each other (4 projections), about 60 degrees from each other (6 projections), or other possibilities. Note that these projections can be equally or unequally angled with respect to each other. For example, two projections can be angled about 180 degrees from each other (e.g., 3 o'clock and 9 o'clock respectfully when resting on a flat surface) and one remaining projection can be angle about 90 degrees from the two projections (e.g., T-shape angling).

For example, the first projection 126 and the second projection 128 may extend from the shaft 124 of the driver 122 in various orientations to one another. The first projection 126 and the second projection 128 may extend from the shaft 124 in opposing directions from one another, at right or acute or obtuse angles to one another, or at any of the other possible orientations between being completely opposing and being completely overlapping. The first projection 126 and the second projection 128 may be so close to another so as to appear to be connected to one another, yet be spaced apart from each other. Furthermore, the first projection 126 and the second projection 128 may be symmetrical to one another, or may be asymmetrical to one another. The first projection 126 and the second projection 128 may be identical in shape to one another, or they may be of different shapes from one another. The first projection 126 and the second projection 128 may each be shaped as a polyhedron, in a form of a flat plane or flat near-plane, rectangular prism, cuboid, triangular prism, pyramidal, cube, pyramid, sphere, cylinder, cone (tapering outwards or inwards), or others. For example, the first projection 126 and the second projection 128 may be identical in size to one another, or the first projection 126 and the second projection 128 may be of different sizes from one another. The first projection 126 and the second projection 128 may each have flat sides, rounded sides, serrated sides, rough sides, knurled sides, texture sides, smooth sides, or polygonal or polyhedronal sides. For each projection of the first projection 126 and the second projection 128, some sides may be identical in size or shape to one another, or may be different in size or shape from one another. The first projection 126 and the second projection 128 may have a flat top and bottom, a rounded top and bottom, a serrated top and bottom, or a polygonal or polyhedronal top and bottom. For each projection of the first projection 126 and the second projection 128, a top side and a bottom side when resting on a flat surface may be identical in size or shape to one another, or may be different in size or shape from one another. The first projection 126 and the second projection 128 may have flat ends or corners, rounded ends or corners, serrated ends, or polygonal or polyhedronal ends.

For example, the first projection 126 and the second projection 128 may be of identical material (e.g., stamped from a same metal or metal alloy), or may be of different materials from one another. Each of the first projection 126 and the second projection 128 may be of different material from the shaft 124, or at least one of the first projection 126 and the second projection 128 may be of same material as the shaft 124. Each of the of the first projection 126 and the second projection 128 may be monolithic with the shaft 124, or at least one of the of the first projection 126 or the second projection 128 may be assembled with the shaft 124.

As shown in FIGS. 8-14 and 17-22, the shaft 124 having the first projection 126 and the second projection 128 provides a technological benefit of stopping the reversible socket 100 while effectively minimizing or stopping the driver 122 from laterally rolling when the driver 122 is placed on an inclined surface (e.g., between about 15 degrees and about 25 degrees), thereby making the driver 122 easier to place, use, and locate. Further, the first projection 126 or the second projection 128 (or the non-annular collar) can be externally coated with a friction-enhancing material (e.g., a rubber) to reduce sliding on a surface, whether inclined or level, or to further prevent or minimize the shaft 124 from laterally rolling off an inclined surface (e.g., between about 15 degrees and about 25 degrees) when the shaft 124 is placed on the inclined surface, thereby making the shaft 124 easier to place onto the inclined surface, locate on the inclined surface, and lift of the inclined surface, especially at a job site.

The set of flat portions 134 is flush with each of the first projection 126 and the second projection 128. However, note that this configuration can vary and at least one flat portion 134 can be non-flush (e.g., raised or lowered) with the first projection 126 or the second projection 128. The first projection 126 and the second projection 128 are symmetrical to each other and are identical to each other in shape and size. However, this configuration can vary where the first projection 126 and the second projection 128 are asymmetrical to each other or are not identical to each other in shape or size. For example, although each of the first projection 126 and the second projection 128 are depicted as generally triangular, this shaping can vary and the first projection 126 or the second projection 128 can be square, rectangular, hexagonal, pentagonal, or others, which can provides a technological benefit of minimizing laterally rolling of an inclined surface or controlling how far the reversible socket 100 is inserted into the shaft 124 or how the drivers 122 are stacked on top of each other.

For example, the shaft 124 may include a first flat portion 134T (e.g., a top side when resting on a flat surface) extending between the first projection 126 and the second projection 128. The first flat portion 134T can be flush with at least one of the first projection 126 or the second projection 128. The shaft 124 may include a second flat portion 134B (e.g., a bottom side when resting on a flat surface) extending between the first projection 126 and the second projection 128. The second flat portion 134B can be flush with at least one of the first projection 126 or the second projection 128. The first flat portion 134T and the second flat portion 1346 may be located at various orientations from one another. The first flat portion 134T and the second flat portion 1346 may be oriented on opposite sides of the shaft 124 from one another, at right or acute or obtuse angles to one another, or at any of the other possible orientations between being completely opposing and being completely overlapping. The first flat portion 134T and the second flat portion 1346 may be so close to one another as to appear to be connected to one another (e.g., a thin sidewall). Furthermore, the first flat portion 134T and the second flat portion 1346 may be symmetrical to one another, or may be asymmetrical to one another. The first flat portion 134 T and the second flat portion 134B may be identical in shape, length, or width to one another, or they may be of different shapes, widths, or lengths from one another. The first flat portion 134T and the second flat portion 1346 may extend along any of longitudinal length of the shaft 124, including along any length of the first end portion 130, along any length of the second end portion 132, along any length of the first end portion 130 and the second end portion 132, between the first end portion 130 and the second end portion 132, or others.

As shown in FIGS. 19-23, the first end portion 130 is shaped to fit into the first open end portion 110 or the second open end portion 116 of the reversible socket 100. This fit may be snug, secure, and removable, as disclosed herein. The second end portion 132 may be shaped in a variety of three dimensional shapes. For example, the second end portion 132 may be shaped with rounded sides so as to form a cylinder or oval, may be shaped to have polygonal sides, including hexagonal, pentagonal, square, rectangular, triangular, heptagonal, octagonal, nonagonal, or decagonal sides, or may be shaped to have irregular sides.

The shaft 124 can include a section 138, including the second end portion 132, that is shaped for mating (e.g., insertion) with a chuck of a power drill (or another electrical, hydraulic, or pneumatic power tool), as shown in FIGS. 15-16, whether mobile or stationary. The section 138 may be shaped with rounded sides so as to form a cylinder or oval, may be shaped with polygonal sides, including hexagonal, pentagonal, square, rectangular, triangular, heptagonal, octagonal, nonagonal, or decagonal sides, or may be shaped to have irregular sides. The section 138 includes a gradual taper, abrupt step, indentation, rounded depression, or protrusion 140, which can help with mating with a chuck of a drill, as shown in FIGS. 15-16.

As shown in FIGS. 8-23, the shaft 124 has a ball-detent mechanism 146 positioned between the first end portion 130 and the second end portion 132. The ball-detent mechanism 146 is positioned between the first end portion 130 and at least one of the first projection 126 or the second projection 128, but can be positioned in other locations on the shaft 124 (e.g., between the second end portion 132 and at least one of the first projection 126 or the second projection 128). The ball-detent mechanism 146 is configured to engage with a corresponding opening 148 (e.g., an internal groove, a channel) or a set of corresponding openings 148, 150 (e.g., internal grooves, channels) defined via the inner surface 156 of the reversible socket 100 when the reversible socket 100 is mounted onto the shaft 124 via the first end portion 130 until at least one of the first projection 126 or the second projection 128. The corresponding opening 148 or the set of corresponding openings 148, 150 defined via the inner surface 156 of the reversible socket 100 are shown in FIGS. 20-23. The ball-detent mechanism 146 includes a sphere (e.g., a ball) and a spring elastically engaging the sphere to secure the reversible socket 100 to the driver 122 or vice versa. For example, there can be at least one ball-detent mechanism 146 (e.g., two, three, four), which can be positioned anywhere on the shaft 124. The ball-detent mechanism 146 can grip and hold the reversible socket 100 by way of any number of the corresponding opening 148 or the set of corresponding openings 148, 150 defined via the inner surface 156 within the reversible socket 100 for axial locking of the ball-detent mechanism 146 against the corresponding opening 148 or the set of corresponding openings 148, 150. As such, if the reversible socket 100 is mounted onto the shaft 124, then each of the first open end portion 110 and the second open end portion 116 of the reversible socket 100 is configured to be mounted onto the first end portion 130 up to or against at least one of the first projection 126 or the second projection 128 of the driver 122, whether or not contacting at least one of the first projection 126 or the second projection 128 of the driver 122. Once the reversible socket 100 is secured to the driver 122 via the ball-detent mechanism 146, as shown in FIGS. 18-23, the driver 122 may thereby transmit a rotational torque to the reversible socket 100 for turning in various type of hexes, bolts, nuts, screws, or fastener into a work piece. As shown in FIGS. 15-16, the second end portion 132 can fit into a chuck 142 of a drill 144 (or another electrical, hydraulic, or pneumatic power tool), in order to powerably rotate the driver 122 relative to the drill 144. The second end portion 132 or the shaft 124 may be shaped or configured to assist in locking or securing the driver 122 to the chuck 142. Therefore, the drill 144 may apply the rotational torque to the driver 122, which may then drive the reversible socket 100, whether the reversible socket 100 is mounted via the first open end portion 110 or the second open end portion 116. For example, the drill 144 can be portable, handheld, battery powered, and have a pistol-grip.

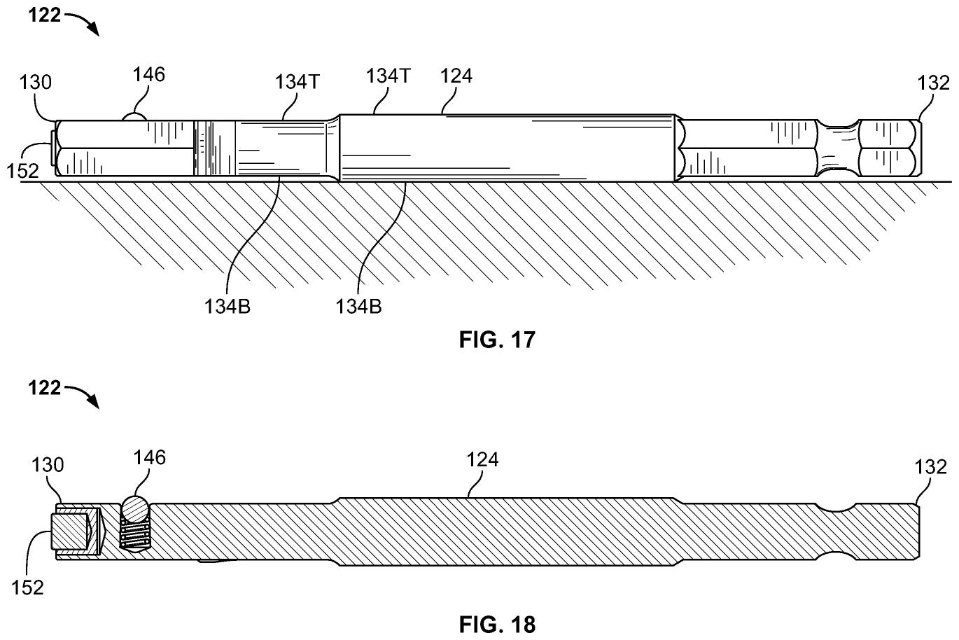

As shown in FIG. 17, the driver 122 lays on a flat surface, where the first flat portion 134T and the second flat portion 1346 are opposite from one another, and the first projection 126 and the second projection 128 are opposite from one another (e.g., 3 o'clock and 9 o'clock) and have flat sides that are flush with the first flat portion 134T and the second flat portion 1346. This provides a technological benefit that the driver 122 can be easily stacked on top of another driver 122, whether same lengths or different lengths, while also being configured to avoid laterally rolling if the flat surface is inclined. This technological benefit provides for many other benefits. For example, one such benefit is an ability to stack the drivers 122 in a way that they take up less space in a workspace. Another benefit is an ability to pack the drivers 122 more tightly while in transit or storage, thereby decreasing an amount of space, and therefore the cost, required to ship drivers 122. Another benefit is that storage containers for the drivers 122 can be made smaller and therefore more economical and simple to use and store.

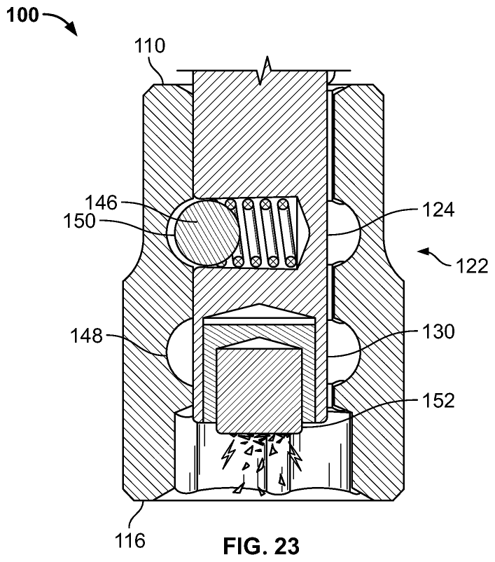

As shown in FIG. 23, the first end portion 130 hosts a magnet 152, although the magnet 152 can be omitted. The magnet 152 is not flush with the first end portion 130, but can be flush with the first end portion 130. If the reversible socket 100 is mounted onto the driver 122, then the magnet 152 may attract and draw in a fastener (e.g., a bolt, a screw, a nut) in order to pull the fastener into the first open end portion 110 or the second open end portion 116. Furthermore, if any metal shavings detach from the fastener when the reversible driver 100 is mounted onto the driver 122 while the driver 122 is being driven by the drill 144, then such metal shavings may be attracted to the magnet 152, allowing for easier cleaning of the metal shavings following use.

The shaft 124 can include a level designed to indicate whether a surface is horizontal (level) or vertical (plumb). For example, the level can be a spirit level or a bubble level secured to the shaft 124 any between the first end portion 130 and the second end portion 132. For example, at least one of the first projection 126, the second projection 128, or the flat side 134 can host the level. The level can provide a technological benefit of knowing what surface to place the driver 122 on and where not to place the driver on in order to effectively minimize rolling of the driver 122 of that surface, especially if inclined. Further, the level can inform a user whether a surface supporting the shaft 124 is level or not level, whether or not the shaft 124 is used with the reversible socket 100.

The driver 122, including any of the shaft 124, the first projection 126, the second projection 128, or the flat side 134, includes a metal or an alloy (e.g., iron, steel, stainless steel, aluminum, nickel, copper, brass, gold, silver, rare earth, nitinol). However, this constituency may differ. For example, the driver 122, including any of the shaft 124, the first projection 126, the second projection 128, or the flat side 134, can include a plastic, a rubber, a wood, shape memory, or others. Likewise, the driver 122, including any of the shaft 124, the first projection 126, the second projection 128, or the flat side 134, is monolithic alone or with respect to the shaft 124, the first projection 126, the second projection 128, or the flat side 134. However, this configuration may differ. For example, the driver 122, including any of the shaft 124, the first projection 126, the second projection 128, or the flat side 134, is an assembly (e.g., fastening, mating, interlocking) alone or with respect to the shaft 124, the first projection 126, the second projection 128, or the flat side 134.

In some embodiments, any devices, as disclosed herein, can be packaged, whether alone or with any others, whether disclosed herein or not, in a kit. For example, the kit can include a package (e.g. plastic bag, sealed bag, storage container, cardboard box, transport package, consumer package, bubble wrap, foam blanket, garment blanket, can, shrink-wrap, molded pulp, blister pack). For example, the package can include a cuboid box, a shipping box, an intermodal container, or others. The package can include a single device or a set of devices, as disclosed herein or not disclosed herein. For example, the kit can include the reversible socket 100 and the driver 122, or multiple reversible sockets 100 and the driver 122, or the reversible socket 100 and multiple drivers 122, or multiple sockets 100 and multiple drivers 122, whether each of the reversible sockets 100 is or is not configured for different fasteners or each of the drivers 122 has different or same lengths. For example, whether or not included in the kit or in the package, the reversible socket 100 and the driver 122 can be provided (e.g., sent, handed) to a user. Further, whether or not included in the kit, there may be a set of instructions (e.g., a diagram, a photo, a user guide, a manual, a paper pamphlet, a sticker, a webpage, a video, an article, augmented reality wizard) instructing a user on how to use the reversible socket 100 or the driver 122 with respect to each other (e.g., how to mount, unmount, maintain, clean, store) or how to have the reversible socket 100 engage (e.g., receive) or disengage (e.g., remove) a fastener (e.g., a bolt, a nut, a screw) such that the driver 122 can drive the reversible socket 100, or other instructions relating to usage of the reversible socket 100 or the driver 122.

Various corresponding structures, materials, acts, and equivalents of all means or step plus function elements in various claims below are intended to include any structure, material, or act for performing the function in combination with other claimed elements as specifically claimed. Various embodiments were chosen and described in order to best disclose various principles of this disclosure and various practical applications thereof, and to enable others of ordinary skill in a pertinent art to understand this disclosure for various embodiments with various modifications as are suited to a particular use contemplated.

This detailed description has been presented for various purposes of illustration and description, but is not intended to be fully exhaustive or limited to this disclosure in various forms disclosed. Many modifications and variations in techniques and structures will be apparent to those of ordinary skill in an art without departing from a scope and spirit of this disclosure as set forth in various claims that follow. Accordingly, such modifications and variations are contemplated as being a part of this disclosure. Scope of this disclosure is defined by various claims, which include known equivalents and unforeseeable equivalents at a time of filing of this disclosure.

What is claimed is:

1. A device comprising:
a driver including a shaft, a first projection, and a second projection, wherein the shaft includes a first end portion and a second end portion, wherein each of the first projection and the second projection extends from the shaft between the first end portion and the second end portion; and
a socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against each of the first projection and the second projection.

2. The device of claim 1, wherein the first projection and the second projection extend from the shaft in opposing directions.

3. The device of claim 1, wherein the first projection and the second projection extend from the shaft not in opposing directions.

4. The device of claim 1, wherein the shaft has a flat portion extending between the first projection and the second projection.

5. The device of claim 1, wherein at least one of the first projection or the second projection has a side that is flush with the shaft.

6. The device of claim 1, wherein the first projection and the second projection are symmetrical to each other.

7. The device of claim 1, wherein the first projection and the second projection are asymmetrical to each other.

8. The device of claim 1, wherein the first projection and the second projection are identical to each other in shape.

9. The device of claim 1, wherein the first projection and the second projection are identical to each other in size.

10. The device of claim 1, wherein the first projection and the second projection are identical to each other in material.

11. The device of claim 1, wherein the first projection and the second projection are monolithic with the shaft.

12. The device of claim 1, wherein the first projection and the second projection are assembled with the shaft.

13. The device of claim 1, wherein the socket includes a first tubular portion and a second tubular portion, wherein the first tubular portion includes the third end portion, wherein the second tubular portion includes the fourth end portion, wherein the first tubular portion has a first outer side with a first surface area, wherein the second tubular portion has a second outer side with a second surface area, wherein the first surface area is larger than the second surface area.

14. The device of claim 13, wherein the first tubular portion gradually tapers to the second tubular portion.

15. The device of claim 14, wherein the socket includes a tapering tubular portion interposed between the first tubular portion and the second tubular portion.

16. The device of claim 13, wherein the first outer side hosts a first size content thereon, wherein the second outer side hosts a second size content thereon.

17. The device of claim 16, wherein the first size content and the second size content are co-planar.

18. The device of claim 16, wherein the first size content and the second size content are not co-planar.

19. The device of claim 13, wherein at least one of the first size content or the second size content is tactile.

20. The device of claim 13, wherein at least one of the first size content or the second size content is not a sticker adhered onto a respective outer side.

21. The device of claim 13, wherein the first tubular portion and the second tubular portion are identical in length.

22. The device of claim 13, wherein the first tubular portion and the second tubular portion are not identical in length.

23. The device of claim 13, wherein the first tubular portion and the second tubular portion are internally in fluid communication with each other.

24. The device of claim 13, wherein the first tubular portion and the second tubular portion are not internally in fluid communication with each other.

25. The device of claim 13, wherein at least one of the first tubular portion or the second tubular portion is perforated thereinto.

26. The device of claim 1, wherein the shaft includes a third projection extending therefrom between the first end portion and the second end portion such that each of the third end portion and the fourth end portion is configured to be mounted onto the first end portion up to or against the third projection.

27. The device of claim 1, wherein the driver includes a level between the first end portion and the second end portion.

28. A device comprising:
a driver including a shaft and a non-annular collar, wherein the shaft includes a first end portion and a second end portion, wherein the non-annular collar extends from the shaft between the first end portion and the second end portion; and
a socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against the non-annular collar.

29. A device comprising:
a driver including a shaft including at least one of (a) a non-annular collar or (b) a first projection and a second projection, wherein the shaft includes a first end portion and a second end portion, wherein at least one of (a) the non-annular collar or (b) each of the first projection and the second projection extends from the shaft between the first end portion and the second end portion; and
a socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against at least one of (a) the non-annular collar or (b) each of the first projection and the second projection.

30. A kit comprising:
a package;
a driver including a shaft including at least one of (a) a non-annular collar or (b) a first projection and a second projection, wherein the shaft includes a first end portion and a second end portion, wherein at least one of (a) the non-annular collar or (b) each of the first projection and the second projection extends from the shaft between the first end portion and the second end portion, wherein the package contains the driver; and
a socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against at least one of (a) the non-annular collar or (b) each of the first projection and the second projection, wherein the package contains the socket.

31. A method comprising:
manufacturing a driver including a shaft including at least one of (a) a non-annular collar or (b) a first projection and a second projection, wherein the shaft includes a first end portion and a second end portion, wherein at least one of (a) the non-annular collar or (b) each of the first projection and the second projection extends from the shaft between the first end portion and the second end portion; and
manufacturing a socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against at least one of (a) the non-annular collar or (b) each of the first projection and the second projection.

32. A method comprising:
providing a driver and a socket to a user, wherein the driver including a shaft including at least one of (a) a non-annular collar or (b) a first projection and a second projection, wherein the shaft includes a first end portion and a second end portion, wherein at least one of (a) the non-annular collar or (b) each of the first projection and the second projection extends from the shaft between the first end portion and the second end portion, wherein the socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against at least one of (a) the non-annular collar or (b) each of the first projection and the second projection; and
instructing the user to respectfully have the third end portion or the fourth end portion engage a fastener while the fourth end portion or the third end portion is respectfully mounted onto the first end portion up to or against at least one of (a) the non-annular collar or (b) each of the first projection and the second projection.

33. A method comprising:
providing a driver and a socket to a user, wherein the driver including a shaft including at least one of (a) a non-annular collar or (b) a first projection and a second projection, wherein the shaft includes a first end portion and a second end portion, wherein at least one of (a) the non-annular collar or (b) each of the first projection and the second projection extends from the shaft between the first end portion and the second end portion, wherein the socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against at least one of (a) the non-annular collar or (b) each of the first projection and the second projection; and
instructing the user to respectfully have the third end portion or the fourth end portion disengage a fastener while the fourth end portion or the third end portion is respectfully mounted onto the first end portion up to or against at least one of (a) the non-annular collar or (b) each of the first projection and the second projection.

34. A method comprising:
accessing a driver and a socket, wherein the driver including a shaft including at least one of (a) a non-annular collar or (b) a first projection and a second projection, wherein the shaft includes a first end portion and a second end portion, wherein at least one of (a) the non-annular collar or (b) each of the first projection and the second projection extends from the shaft between the first end portion and the second end portion, wherein the socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against at least one of (a) the non-annular collar or (b) each of the first projection and the second projection;
inserting a fastener into the third end portion or the fourth end portion while the fourth end portion or the third end portion is respectfully mounted onto the first end portion up to or against at least one of (a) the non-annular collar or (b) each of the first projection and the second projection.

35. A method comprising:
accessing a driver and a socket, wherein the driver including a shaft including at least one of (a) a non-annular collar or (b) a first projection and a second projection, wherein the shaft includes a first end portion and a second end portion, wherein at least one of (a) the non-annular collar or (b) each of the first projection and the second projection extends from the shaft between the first end portion and the second end portion, wherein the socket having a third end portion and a fourth end portion, wherein the third end portion is open according to a first size, wherein the fourth end portion is open according to a second size, wherein the first size is different from the second size, wherein each of the third end portion and the fourth end portion is configured to be mounted onto the first end portion up to or against at least one of (a) the non-annular collar or (b) each of the first projection and the second projection;
removing a fastener from the third end portion or the fourth end portion while the fourth end portion or the third end portion is respectfully mounted onto the first end portion up to or against at least one of (a) the non-annular collar or (b) each of the first projection and the second projection.
